(19) United States
(12) Patent Application Publication
(10) Pub. No.: US 2008/0320387 A1
(43) Pub. Date: Dec. 25, 2008

(54) INFORMATION DISPLAYING DEVICE AND INFORMATION DISPLAYING METHOD

(75) Inventors: Mikio Sasaki, Tokyo (JP); Takehisa Mizuguchi, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/947,113

(22) Filed: Nov. 29, 2007

(30) Foreign Application Priority Data
Jun. 22, 2007 (JP) JP2007-165546

(51) Int. Cl. G06F 17/27

(52) U.S. Cl. 715/273

(57) ABSTRACT

An information displaying device 1 reads and analyzes each screen information defined as information showing a predetermined screen, and displays a screen for each screen information. An analyzed information managing unit 5 stores and manages analyzed displaying information which is displaying information after analysis. A reading unit 2 reads the screen information. An analyzing unit 3 analyzes the screen information read and outputs analyzed result including specifying information specifying the displaying information. A displaying format determining unit 7 inputs the analyzed result, asks the analyzed information managing unit 5 to obtain the analyzed displaying information of the displaying information specified by the specifying information, and when the analyzed displaying information is obtained, determines a displaying format of the screen based on the analyzed displaying information and analyzed result inputted from the analyzing unit 3. An information outputting unit 8 displays the screen according to the displaying format determined.

### BACKGROUND OF THE INVENTION

1. Field of the Invention

The present invention relates to an information outputting device which uses a Web browser displaying contents, in particular, to an information displaying device which carries out displaying/manipulating information by using Web contents in equipments of which memory capacity mounted and processing performance are limited such as built-in equipments.

2. Description of the Related Art

It has been popular to obtain information from the Internet to browse the Web. The Web browser obtains the contents through the network, analyzes and displays. These operations are done for each of the pages that have been read. Namely, every time of transiting from a certain page to the next page, the contents are analyzed.

JP11-15819 (“Display Acceleration System for Web Browser”) discloses an art to accelerate display of the Web browser. This prior art does not analyze the contents each time, but receives intermediate codes which are analyzed result information from the server, and reduces the time for analyzing operation by using the intermediate codes.

[Patent Document 1] JP11-15819

In a small-sized built-in information equipment such as a mobile phone, a mobile information terminal, a car navigation system, memories used and processing performance are limited. The small-sized built-in information equipment cannot use computational resource such as a processor with high processing performance or a memory with a large capacity like a PC (Personal Computer). Therefore, in many cases, the small-sized built-in information equipment takes long time to carry out analyzing operation.

In JP11-15819, although the processing time is reduced by receiving/using the intermediate codes without analyzing the received contents every time, an exclusive Web server is necessary to provide the intermediate codes.

### SUMMARY OF THE INVENTION

The present invention aims to provide an information displaying device which can display at a high speed, while the exclusive Web server is not necessary.

According to one aspect of the present invention, an information displaying device for reading and analyzing each of screen information which is defined as information showing a predetermined screen and includes specifying information specifying displaying information necessary to display the predetermined screen, and displaying the predetermined screen for each of the screen information analyzed, the information displaying device includes: a managing unit storing analyzed displaying information which is the displaying information after analyzing and managing the analyzed displaying information stored; a reading unit sequentially reading each of the screen information; an analyzing unit inputting the screen information read by the reading unit, generating analyzed result including the specifying information included in the screen information by analyzing the screen information inputted, and outputting the analyzed result generated; a displaying format determining unit inputting the analyzed result outputted by the analyzing unit, asking the managing unit to obtain the analyzed displaying information of the displaying information specified by the specifying information included in the analyzed result inputted, and when the analyzed displaying information is obtained from the managing unit, determining a displaying format of the predetermined screen shown by the screen information which is an origin of the analyzed result inputted from the analyzing unit based on the analyzed displaying information obtained from the managing unit and the analyzed result inputted from the analyzing unit; and an information displaying unit displaying the predetermined screen according to the displaying format determined by the displaying format determining unit.

The reading unit reads predetermined displaying information, the analyzing unit generates the analyzed displaying information of the predetermined displaying information by analyzing the predetermined displaying information read by the reading unit, and the managing unit stores the analyzed displaying information of the predetermined displaying information generated by the analyzing unit.

At least two of the screen information read by the reading unit include specifying information specifying same displaying information.

The analyzing unit inquires the managing unit if the analyzed displaying information of the displaying information specified by the specifying information included in the analyzed result generated exists or not, if the analyzed displaying information of the displaying information does not exist in the managing unit as a result of inquiry, reads the displaying information specified by the specifying information from a predetermined storage device using the reading unit, analyzes the displaying information read, outputs the analyzed result of the screen information to the displaying format determining unit as well as registers analyzed result of the displaying information with the managing unit as new analyzed displaying information, and if the analyzed displaying information of the displaying information exists in the managing unit as a result of inquiry, does not read the displaying information but outputs the analyzed result of the screen information to the displaying format determining unit.

The specifying information includes a predetermined identifier, the analyzing unit, when the displaying information is read from the predetermined storage device using the reading unit, registers the analyzed displaying information of the displaying information read from the predetermined storage device with the managing unit as identifier related information, and the managing unit, when the reading unit reads next screen information, deletes information stored other than the identifier related information.

The information displaying device further includes: a notifying unit, as well as keeping correspondence information showing correspondence between the displaying information and the screen information, each time when the reading unit reads the screen information, confirming if the displaying information corresponding to the screen information read by the reading unit exists or not by referring to the correspondence information, as a result of confirmation, if the displaying information exists, checking if the displaying information related to the confirmation has been already notified to the analyzing unit or not, and if not notified yet, notifying the analyzing unit of the displaying information related to the confirmation, and the analyzing unit, when notified by the notifying unit, reads the displaying information related to notification from a predetermined storage device using the reading unit, analyzes the displaying information read and registers analyzed result with the managing unit as new analyzed displaying information.

According to another aspect of the invention, an information displaying method performed by an information displaying device reading and analyzing each of screen information which is defined as information showing a predetermined screen and includes specifying information specifying displaying information necessary to display the predetermined screen, and displaying the predetermined screen for each of the screen information analyzed, the information displaying method includes: by a managing unit, storing analyzed displaying information which is the displaying information after analyzing and managing the analyzed displaying information stored; by a reading unit, sequentially reading each of the screen information; by an analyzing unit, inputting the screen information read by the reading unit, generating analyzed result including the specifying information included in the screen information by analyzing the screen information inputted, and outputting the analyzed result generated; by a displaying format determining unit, inputting the analyzed result outputted by the analyzing unit, asking the managing unit to obtain the analyzed displaying information of the displaying information specified by the specifying information included in the analyzed result inputted, and when the analyzed displaying information is obtained from the managing unit, determining a displaying format of the predetermined screen shown by the screen information which is an origin of the analyzed result inputted from the analyzing unit based on the analyzed displaying information obtained from the managing unit and the analyzed result inputted from the analyzing unit; and by an information displaying unit, displaying the predetermined screen according to the displaying format determined by the displaying format determining unit.

The present invention can provide an information displaying device which can display at a high speed, while the exclusive Web server is not necessary.

### BRIEF DESCRIPTION OF THE DRAWINGS

A complete appreciation of the present invention and many of the attendant advantages thereof will be readily obtained as the same becomes better understood by reference to the following detailed description when considered in connection with the accompanying drawings, wherein:

FIG. 1 shows an example of an external appearance of an information displaying device 1 according to the first embodiment;

FIG. 2 shows an example of a hardware configuration of the information displaying device 1 according to the first embodiment;

FIG. 3 is a block diagram showing a configuration of the information displaying device 1 according to the first embodiment;

FIG. 4 shows an example of describing style information according to the first embodiment;

FIG. 5 shows analyzed result of screen information and style information, and determination of an outputting format according to the first embodiment;

FIG. 6 shows a process of a displaying format determining unit 7 according to the first embodiment;

FIG. 7 is a flowchart showing a process of the displaying format determining unit 7 according to the first embodiment;

FIG. 8 is a block diagram showing a configuration of the information displaying device 1 according to the second embodiment;

FIG. 9 shows an example of describing common resource according to the second embodiment;

FIG. 10 is a flowchart showing a process of an analyzing unit 3 according to the second embodiment;

FIG. 11 shows an example of describing common resource according to the third embodiment;

FIG. 12 is a flowchart showing a process of the analyzing unit 3 according to the third embodiment;

FIG. 13 is a block diagram showing a configuration of the information displaying device 1 according to the fourth embodiment;

FIG. 14 shows an example of describing common resource according to the forth embodiment; and

FIG. 15 is a flowchart showing processes of the analyzing unit 3 and the displaying format determining unit 7 according to the fourth embodiment.

### DESCRIPTION OF THE PREFERRED EMBODIMENT

### Embodiment 1

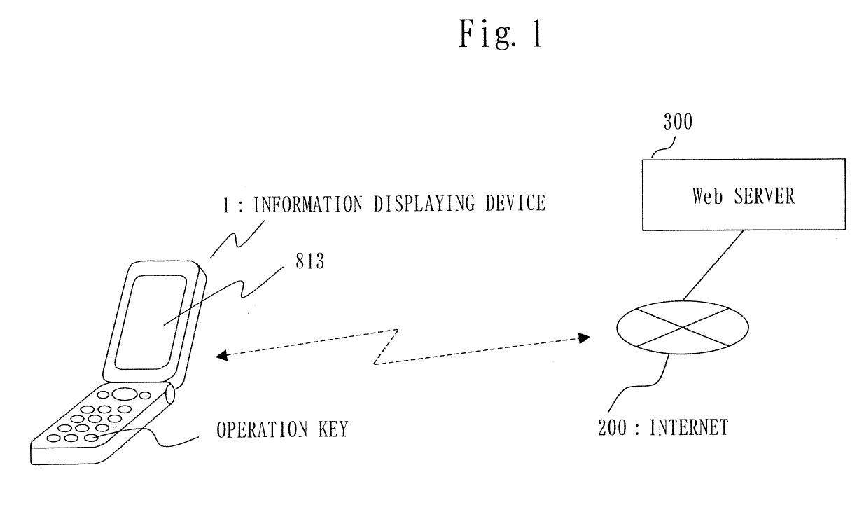

FIG. 1 shows an example of an external appearance of an information displaying device 1 which is a computer. The information displaying device 1 is embodied as, for example, a mobile phone or a portable information device. The information displaying device 1 is provided with a displaying device 813 for displaying a screen and an operation key 814.

The information displaying device 1 is connected to the Internet 200 and communicable with a Web server 300. The information displaying device 1 can download contents from the Web server 300 and display the contents. Here, it is not limited to the Internet 200, but can be also another network such as LAN (Local Area Network), WAN (Wide Area Network), etc.

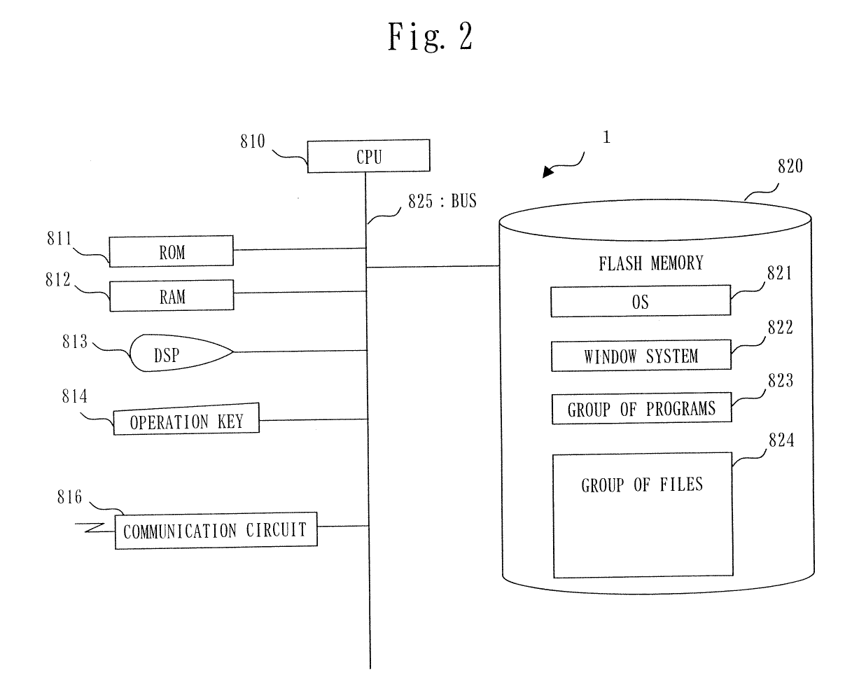

FIG. 2 shows an example of hardware resource of the information displaying device 1. In FIG. 2, the information displaying device 1 includes a CPU (Central Processing Unit) 810. The CPU 810 is connected to a ROM (Read Only Memory) 811 a RAM (Random Access Memory) 812, a displaying device 813, an operation key 814, a communication circuit 816, and a flash memory 820 via a bus 825, and controls these hardware devices.

The RAM 812 is an example of a volatile memory. Recording medium such as the ROM 811, the flash memory 820, etc. are examples of a non-volatile memory. These are examples of a memory device, a memory unit or a storage unit. The communication circuit 816, the operation key 814, etc. are examples of an input unit or an inputting device. Further, the communication circuit 816, the displaying device 813, etc. are examples of an output unit or an outputting device. The communication circuit 816 can be connected to the Internet 200.

The flash memory 820 stores an operating system (OS) 821, a window system 822, a group of programs 823, and a group of files 824. The group of programs 823 is executed by the CPU 810, the operating system 821, and the window system 822.

Programs for implementing functions explained by “-- unit” in the following embodiment are stored in the group of programs 823. The programs are read and executed by the CPU 810.

The group of files 824 stores information explained in the following embodiment as “judged result of --”, “calculated result of --”, “extracted result of --”, “generated result of --”, and “processed result of --”, data, signal values, variables, parameters, etc. as each of items of “-- file”, “-- database”. “-- file” and “-- database” are stored in the recording medium such as discs or memories. The information, data, signal values, variables, parameters stored in the recording medium such as discs or memories are read by the CPU 810 through a reading circuit to a main memory and a cache memory and used for performance of the CPU such as extraction, search, reference, comparison, operation, calculation, processing, output, printing, display, etc. During the performance of the CPU such as extraction, search, reference, comparison, operation, calculation, processing, output, printing, display, the information, data, signal values, variables, and parameters are temporarily stored in a main memory, a cache memory, a buffer memory.

Further, in the following explanation of embodiment, the data and the signal values are stored in the recording medium such as a memory of the RAM 812, the flash memory 820, and a magnetic recording medium.

Further, “-- unit” explained in the following explanation of embodiment can be “-- device”, “-- equipment”, and “-- means”, and can be also “-- step”, “-- procedure”, and “-- process”. Namely, “-- unit” explained can be embodied by the firmware stored in the ROM 811. In another way, it can be implemented only by software, only by hardware such as elements, devices, boards, wiring, etc., or a combination of software and hardware, or further a combination with firmware. Firmware and software are stored as programs in the recording medium such as a flash memory, a magnetic disc, a compact disc, a mini disc, etc. The programs are read by the CPU 810 and executed by the CPU 810. Namely, the programs cause a computer to function as “-- unit” that will be discussed in the following. Or the programs cause a computer to perform a procedure or a method that will be explained as “-- unit” in the following.

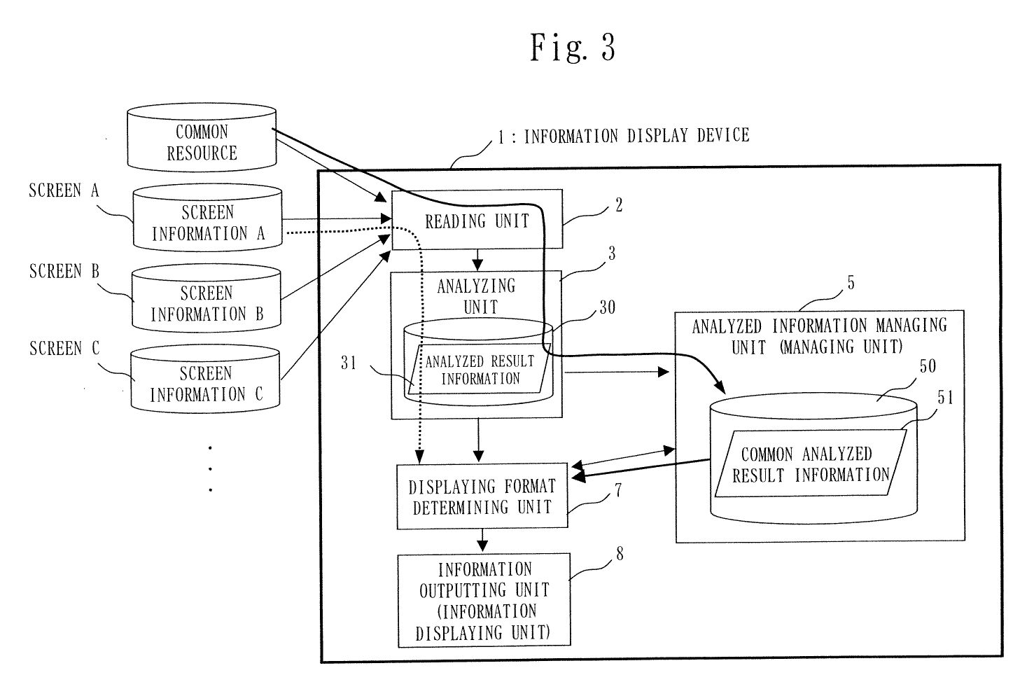

FIG. 3 is a block diagram showing a configuration of an information displaying device 1 according to the first embodiment. The information displaying device 1 is a built-in equipment such as a small calculator, a mobile phone or a car navigation system having a browsing function. As shown in FIG. 3, the information displaying device 1 includes a reading unit 2, an analyzing unit 3, an analyzed information managing unit 5 (a managing unit), a displaying format determining unit 7, and an information outputting unit 8 (an information displaying unit). The analyzing unit 3 includes an analyzed result information storing unit 30 for storing analyzed result information 31 discussed later. The analyzed information managing unit 5 includes a common analyzed result information storing unit 50 for storing common analyzed result information 51 discussed later.

The operation will be explained by referring to FIG. 3.

(1) The reading unit 2 obtains screen information of a displaying target (contents in the case of general Web browser). Here, “screen information” means information defining a predetermined screen. The screen information includes specifying information for specifying displaying information which is necessary to display a predetermined screen (for example, common resource, style information discussed later). The screen information includes various data by which the display screen is formed such as a text file written in HTML (Hyper Text Markup Language) format and an image file, etc. Further, although various information such as information on the network, information in a memory area within a device, etc. can be the information of reading target by the reading unit 2, such information is not limited to these.
(2) The analyzing unit 3 scans the data obtained by the reading unit 2 and carries out process to align the information and to arrange elements to be displayed on the screen, etc.
(3) The analyzed result information 31 is information obtained by the analyzing unit 3 as the analyzed result.
(4) The analyzed information managing unit 5 manages the analyzed result information 31 by discriminating if the analyzed result information 31 is the common analyzed result information 51 or not. Namely, the information analyzed by the analyzing unit 3 is called as the analyzed result information 31, and among the analyzed result information 31, the analyzed result information to be stored and managed by the analyzed information managing unit 5 is called as the common analyzed result information 51. The information is named with “common”, because the common analyzed result information 51 stored by the analyzed information managing unit 5 is commonly used by a plurality of screen information as discussed later.
(5) The common analyzed result information 51 is, in principle, information regarding the analyzed result for common resource which will be discussed later.
(6) The displaying format determining unit 7 determines a displaying format of the screen defined by the screen information based on the analyzed result information 31 and the common analyzed result information 51.
(7) The information outputting unit 8 carries out an outputting process (a screen displaying process) according to the displaying format determined by the displaying format determining unit 7.

Further, the screen information is to be defined for each screen to be displayed. The screen information includes, for example, contents written in HTML or XML (eXtensible Markup Language), style information which will be explained in the next section, Script which is necessary for carrying out the process, etc.

### (Style Information)

In most cases of displaying information by the browser, some information is used commonly for a plurality of Web pages. Definition information for screen display called style information (an example of displaying information) is an example of this “commonly used information”. The style information defines information related to the output (display) such as a background color, a type and size of characters for elements forming the screen. CSS (Cascading Style Sheet) defined by the World Wide Web Consortium is a typical example of the style information.

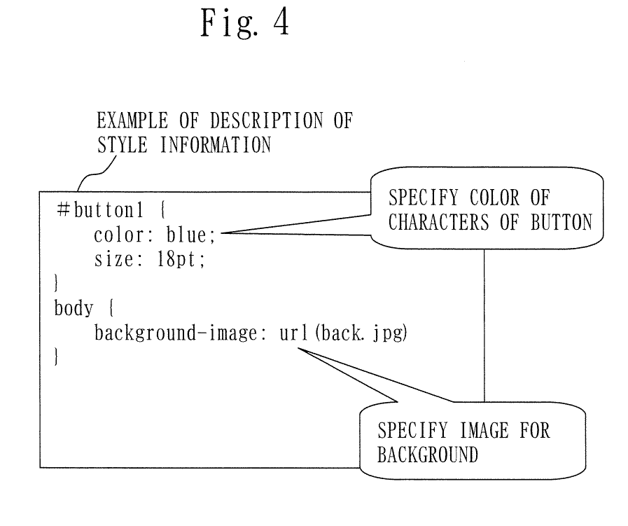

FIG. 4 shows an example of describing the style information. FIG. 4 is described in a form which is a type of CSS. This example describes information of a color of characters of a button and an image for background.

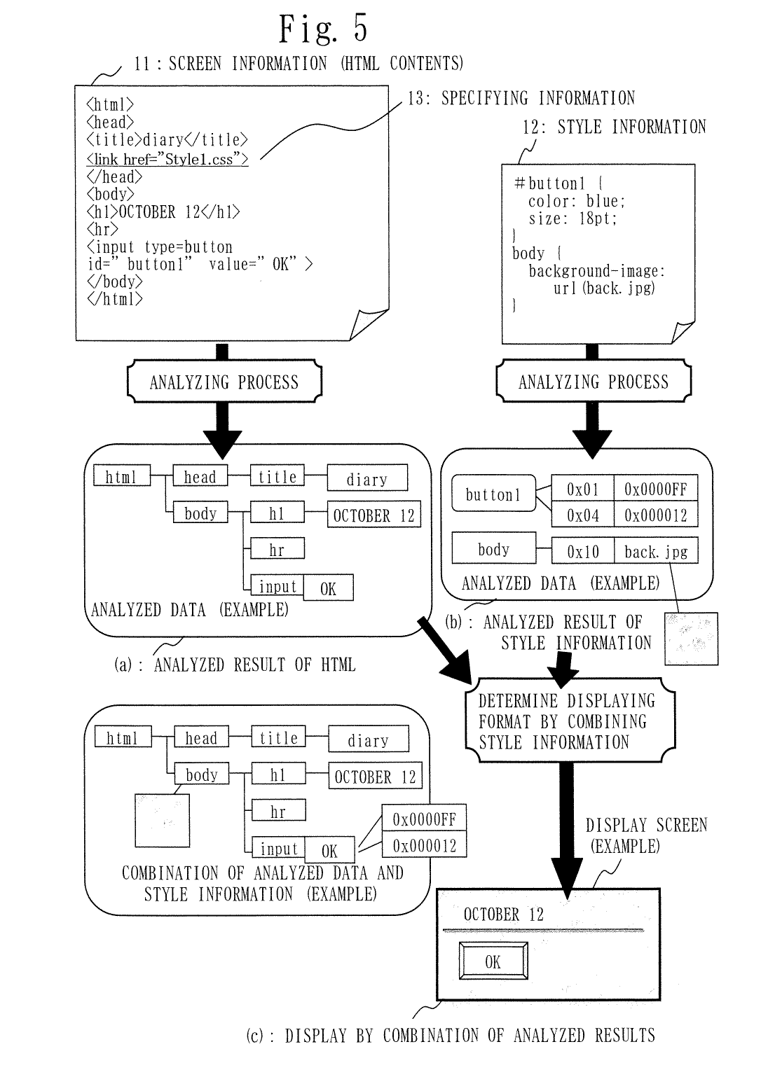

Next, a method will be discussed to reflect the style information as screen information. FIG. 5 shows screen information 11 and style information 12 specified by the screen information 11. The description of <link.href=“Style.css”> of the screen information 11 is specifying information 13 for specifying the style information 12 (an example of displaying information).

By analyzing a structured document such as HTML documents, data having a tree structure, in which relationship between elements are made related by parent-child relationship, etc. is obtained. An example shown as “(a) Analyzed result of HTML” in FIG. 5, elements such as html, head, body, input, etc. are made related in the describing order.

Further, by analyzing the style information, a combination of adaptive condition and information related to display in the case which satisfies the condition can be obtained as analyzed result information. In an example shown as “(b) Analyzed result of style information” in FIG. 5, information showing a color of characters which match an identifier “button” is blue as description is shown by, for example, “0x01” in the case of a color of characters which is a code unique to the condition “button1”. It shows that the analyzed result is obtained showing blue color is represented by a numeral value of “0x0000FF”. The example shows the analyzed result information is shown by code values to facilitate the next process; however, it is also possible to maintain the original values such as “blue” and “18”, and it is not prescribed.

In the case of displaying, display is done after a displaying format is determined by combining tree structured data having nodes of elements as shown in FIG. 5 as “(a) Analyzed result of HTML” and defining information of outputs for each of the elements as shown in FIG. 5 as “(b) Analyzed result of style information”.

“(c) Display by combination of analyzed results” in FIG. 5 shows a case in which a result is outputted when an image of back.jpg is specified as background of body elements, and blue characters of 0x0000FF is specified as characters of OK of the button.

### (Common Resource)

Common screen style information is defined and used also in the case of using a browser for outputting information such as displaying equipment information. The information displaying device 1 promotes efficiency of resource to be used and processing by commonly using information when the information such as the style information is used for multiple screens. Hereinafter, the screen information which is commonly used for multiple screens is called as “common resource”.

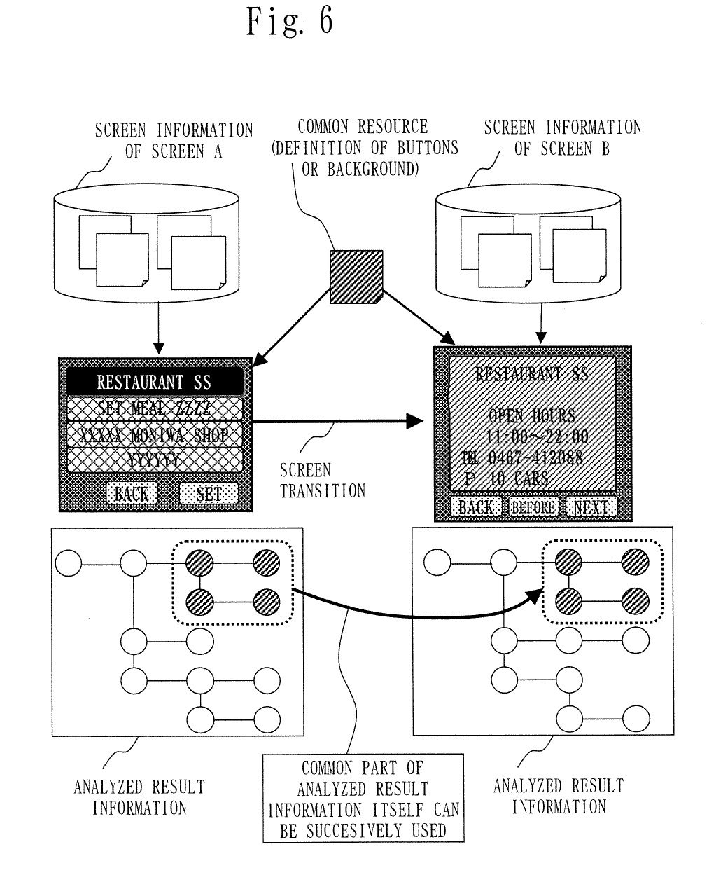

FIG. 6 shows an example of how to use common resource. For example, when a screen A and a screen B use common background, button colors, font sizes, the style information which defines these common information can be used as common resource. The analyzed result information of the common resource (common analyzed result information) is used for displaying process together with other analyzed result information of screen information.

In the first embodiment, the common resource described above is read and analyzed at a prior stage to displaying the screen. For example, when there is such common resource that is common to all screens to be displayed, the common resource is read and analyzed at the time of starting the information displaying device 1. Processes of prior reading and analyzing of the common resource will be explained by referring to FIG. 3.

### (Reading/Analyzing Operation of Common Resource)

(1) In FIG. 3, first, the reading unit 2 reads common resource 60. The common resource 60 is, for example, the style information described by the style description as has been discussed in the explanation for FIG. 4. Various sources from which the common resource 60 is read can be considered such as devices of communicating partner through the network (an example of a predetermined storage device), HDD (Hard Disk Drive) (an example of a predetermined storage device) installed in or connected to the device (the information displaying device 1), ROM (an example of a predetermined storage device), etc. according to usage of the device (the information displaying device 1); however, the source to be read (a predetermined storage device) is not prescribed as long as the common resource 60 can be read.
(2) The analyzing unit 3 analyzes the information (the common resource 60) read by the reading unit 2, the analyzed result of the common resource 60 is outputted to the analyzed information managing unit 5. “To analyze” means, for example, to convert to a format as shown by “(b) Analyzed result of style information”
(3) The analyzed information managing unit 5 stores and manages the analyzed result information outputted from the analyzing unit 3 as common analyzed result information 51. Here, the information outputting unit 8 does not display at this time.

### (Operation of Reading, Analyzing, Displaying the Screen Information A)

(1) Next, the reading unit 2 reads the screen information A at a timing when display is necessary such as, for example, when it is instructed to display the screen of the initial screen A.
(2) The analyzing unit 3 analyzes the screen information A read by the reading unit 2 and maintains as the analyzed result information 31. The analyzing process which is done by the analyzing unit 3 here means a process to convert the screen information described in HTML into a form that is easy to process internally such as a tree structure as shown in FIG. 5 as “(a) Analyzed result of HTML”. The analyzing unit 3 outputs the analyzed result information 31 to the displaying format determining unit 7. The analyzed result information 31 of the screen information A includes the specifying information 13 shown in FIG. 5.

### (Operation of the Displaying Format Determining Unit 7 for the Analyzed Result of the Screen Information A)

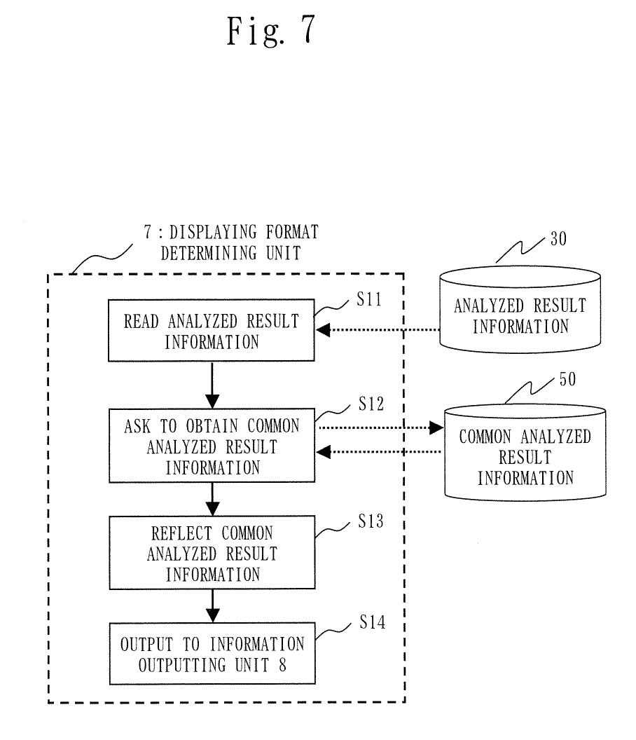

FIG. 7 shows an operation procedure of the displaying format determining unit 7. First, the displaying format determining unit 7 reads the analyzed result information 31 of the screen information A from the analyzing unit 3 (S11). Next, the displaying format determining unit 7 asks the analyzed information managing unit 5 to obtain the common analyzed result information 51 (an example of analyzed displaying information) related to specification of the specifying information 13 included in the analyzed result information 31 (S12). The analyzed information managing unit 5 stores the analyzed result of the common resource 60 as the common analyzed result information 51 beforehand. Because of this, the displaying format determining unit 7 can obtain the common analyzed result information 51 which is the analyzed result of the common resource 60 from the analyzed information managing unit 5. The displaying format determining unit 7 determines an outputting format (a displaying format) of the screen A by reflecting the common analyzed result information 51 obtained from the analyzed information managing unit 5 to the analyzed result information 31 of the screen information A (S13). A method to reflect is, for example, to apply the style information which matches the analyzed result information having a tree structure as discussed in the explanation for FIG. 5. Then, the displaying format determining unit 7 outputs the information of the determined displaying format of the screen A to the information outputting unit 8 (S14). The information outputting unit 8 uses the information of the displaying format outputted by the displaying format determining unit 7 to output the screen A.

### (Operation of Reading, Analyzing, Displaying the Screen Information B)

An operation to transit the screen to the next screen B will be explained. The operation for the screen B will be done similarly to the one for the screen A. To display the next screen B, the reading unit 2 reads screen information B of the screen B. At this time, the analyzing unit 3 deletes the analyzed result information 31 of the previous screen A. The screen information B read by the reading unit 2 is analyzed by the analyzing unit 3, and the analyzed result information 31 of the screen information B is obtained. The displaying format determining unit 7 inputs the analyzed result information 31 of the screen information B (S11). Similarly to the case to process the first screen A, the displaying format determining unit 7 uses the common analyzed result information 51 stored by the analyzed information managing unit 5 (S12), reflects the common analyzed result information 51 to the analyzed result information 31 of the screen information B (S13), and determines the displaying format for the screen B. The displaying format determining unit 7 outputs the information of the displaying format to the information outputting unit 8 (S14). The information outputting unit 8 outputs (displays) the screen B based on the information of displaying format outputted by the displaying format determining unit 7.

### (Deletion of the Analyzed Result Information 31 of the Previous Screen)

In the above example, the analyzing unit 3 deletes the analyzed result information of the previous screen before analyzing the next screen. Namely, although in the above explanation, the analyzing unit 3 deletes the analyzed result information 31 of the previous screen information A at the time of reading the screen information B, a timing for deletion is arbitrary and when it is judged to be unnecessary such that the analyzed result information 31 of the screen information A is maintained and deleted after completing the display of the screen information B.

The information displaying device 1 according to the above first embodiment processes the common resource beforehand to maintain as the common analyzed result information 51, uses the common analyzed result information 51 for displaying the screen, and does not analyze the common resource 60. Because of this, the displaying process can be completed at a higher speed.

In the above first embodiment, the information displaying device 1 has been explained; however, it is also possible to grasp the operation of the information displaying device 1 as information displaying program to be executed by a computer by treating the operation of each of configured elements of the information displaying device 1 as a process. Further, it is also possible to grasp the operation of the information displaying device 1 as information recording medium by which the program is recorded. Yet further, it is also possible to grasp the operation of each of configured elements of the information displaying device 1 as an information displaying method performed by the information displaying device 1.

### Embodiment 2

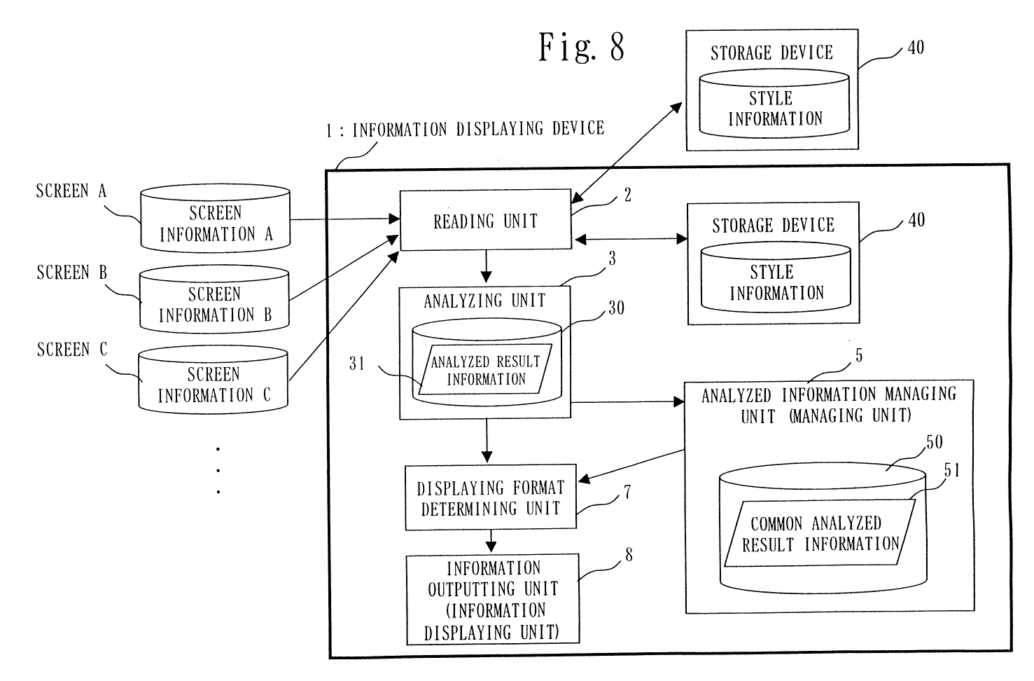

The second embodiment will be explained using FIGS. 8 through 0. FIG. 8 is a block diagram showing a configuration of the information displaying device 1 according to the second embodiment. Although configured elements of the information displaying device 1 of the second embodiment is the same as ones of the information displaying device 1 of the first embodiment, the process differs. Different from the first embodiment, the information displaying device 1 of the second embodiment does not read the common resource 60 beforehand. The information displaying device 1 of the second embodiment, when the screen transition occurs, uses a part of the information used for the previous screen, for example, the analyzed result information of the screen information A as the common analyzed result information, which can omit, for example, a part of the analyzing process of the screen information B.

### (Output Operation of the Initial Screen A)

An output operation of the initial screen A will be explained.

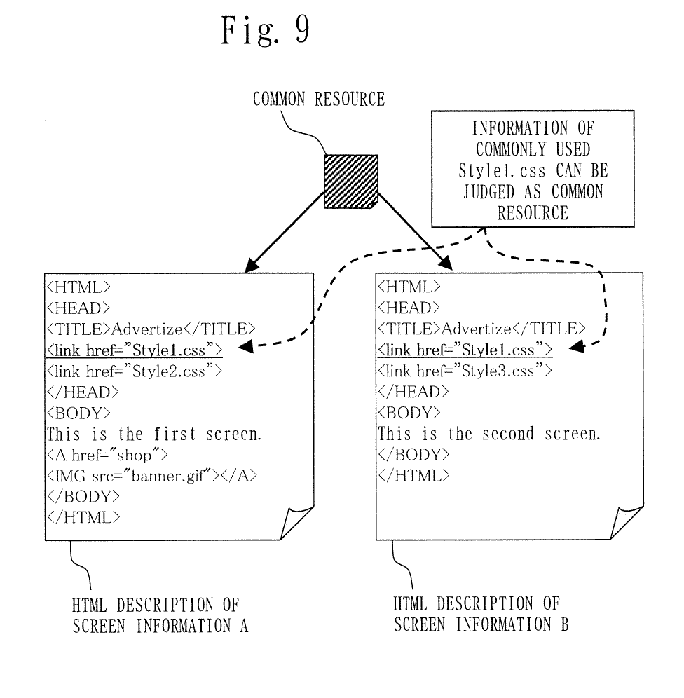

(1) First, the reading unit 2 reads the screen information A which is an outputting object.
(2) The analyzing unit 3 inputs and analyzes the screen information A read by the reading unit 2. On analyzing the screen information A, the analyzing unit 3 checks if “style information” (an example of displaying information) related to the screen information A is written in the screen information A or not. Here, the analyzing unit 3 confirms the “style information”, since it is previously set in the analyzing unit 3 to confirm the style information. For example, in the case of web contents written by HTML, the style information can be identified by URL. FIG. 9 shows an example of description for a case when HTML is used as the screen information of Web contents. In HTML, referencing (specifying) style information is written using a link element as shown in FIG. 9. In such a case, URL (Uniform Resource Locator) is used as an identifier. In FIG. 9, identifying information (an example of specifying information) showing the style information is written as “Style1.css” or “Style2.css”. Using these identifying information, the analyzing unit 3 reads corresponding style information from a “predetermined storage device” storing corresponding style information. In the example of the screen information A of FIG. 9, Style Information 1 and Style Information 2 are specified by the identifying information of “Style1.css” and “Style2.css”.

### (Explanation of Detailed Operation of the Analyzing Unit 3 in the Output Operation of the Initial Screen A)

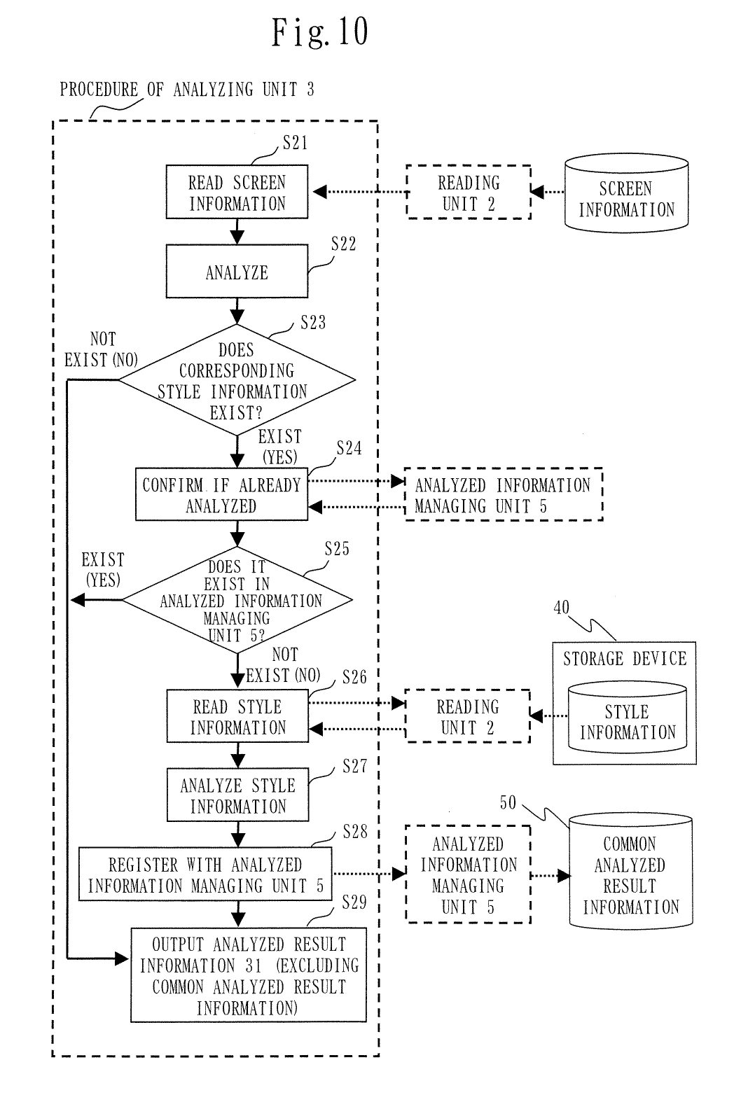

Next, by referring to FIG. 10, an analyzing procedure of the screen information by the analyzing unit 3 will be explained in detail. The analyzing unit 3 inputs the screen information A from the reading unit 2 (S21).

(1) Scanning the HTML description of the screen information A shown in FIG. 9, the analyzing unit 3 confirms the identifying information of “Style1.css” and “Style2.css” showing that Style Information 1 and Style Information 2 which are the style information related to the screen information A are necessary (S22).
(2) When the identifying information showing the related style information is necessary exists (YES at S23), the analyzing unit 3 inquires the analyzed information managing unit 5 if corresponding common analyzed result information 51 exists in the common analyzed result information storing unit 50 or not (S24). In this example, the analyzing unit 3 inquires the analyzed information managing unit 5 if Style Information 1 and Style Information 2 which have been already analyzed exist or not. If exist, the analyzing unit 3 does not analyze Style Information 1 and Style Information 2 (YES at S25). In this case, at the time when the screen information A is read, the style information (common analyzed result information) does not exist in the common analyzed result information storing unit 50. Accordingly, the process moves to S26.
(3) If the corresponding analyzed information does not exist in the analyzed information managing unit 5 (the common analyzed result information storing unit 50) (NO at S25), the analyzing unit 3 reads the style information specified by the identifying information (the specifying information) such as “Style1.css” or “Style2.css”, etc. based on the identifying information such as URL, etc. written in the screen information A from a predetermined storage device 40 using the reading unit 2 (S26).
(4) Further, the analyzing unit 3 analyzes the style information read from the storage device 40 using the reading unit 2 (S27), and registers the analyzed result information which is an analyzed result of the style information with the common analyzed result information storing unit 50 of the analyzed information managing unit 5 as “the common analyzed result information 51” (an example of analyzed displaying information) (S28). On this registration, the analyzing unit 3 registers the analyzed result of the style information with the common analyzed result information storing unit 50 of the analyzed information managing unit 5 as the common analyzed result information together with the identifying information of “Style1.css” and “Style2.css”. The analyzed information managing unit 5 maintains and manages the analyzed result information of the style information as the common analyzed result information by a combination with the identifier (the identifying information).
(5) At S29, the analyzing unit 3 outputs the analyzed result information 31 of the screen information A to the displaying format determining unit 7. The analyzed result information 31 of the screen information A has the same contents as the case of the first embodiment. Namely, the analyzed result information 31 which the analyzing unit 3 outputs to the displaying format determining unit 7 at S29 does not include the style information analyzed at S27 (the common analyzed result information). The style information analyzed at S27 (the common analyzed result information) is obtained by the displaying format determining unit 7 at S12 of FIG. 7 as explained in the following.
(6) The subsequent process by the displaying format determining unit 7 is the same as the one shown in FIG. 7 in the first embodiment. Namely, the displaying format determining unit 7 reads the analyzed result information 31 of the screen information A from the analyzing unit 3 (S11). Next, the displaying format determining unit 7 asks the analyzed information managing unit 5 to obtain the style information related to specification of the identifying information (the specifying information) included in the analyzed result information 31 (Style Information 1 and Style Information 2, in this case) (S12). Necessary style information is stored in the common analyzed result information storing unit 50 through the processes of S26 through S28 in FIG. 10. Because of this, the displaying format determining unit 7 can obtain the style information specified by the identifying information from the analyzed information managing unit 5. The displaying format determining unit 7 reflects the style information obtained from the analyzed information managing unit 5 to the analyzed result information 31 of the screen information A and determines an outputting format (a displaying format) of the screen A (S13). Then, the displaying format determining unit 7 outputs the information of the determined displaying format of the screen A to the information outputting unit 8 (S14). The information outputting unit 8 uses the information of the displaying format outputted by the displaying format determining unit 7 and carries out screen output of the screen A.

### (Reading Screen Information B)

Next, a process at screen transition will be explained. The flow of the process is the same as the one of the case for the screen information A from reading the screen information B by the reading unit 2 up to transferring to the analyzing unit 3

Here, at the screen transition (switching), the common analyzed result information registered with the analyzed information managing unit 5 (analyzed Style Information 1 and Style Information 2, in this case) is kept maintained. Further, the screen information B uses Style Information 1 and Style Information 3 as shown in FIG. 9.

### (Operation of the Analyzing Unit 3 in Outputting Operation of the Screen B)

The analyzing unit 3 reads the screen information B (S21).

(1) Scanning the description of the screen information B, the analyzing unit 3 confirms the identifying information of “Style1.css” and “Style3.css” as the style information related to the screen information B (S22).
(2) Consequently, the process moves to S22, YES at S23, and S24. At S24, the analyzing unit 3 inquires the analyzed information managing unit 5 if Style Information 1 and Style Information 3 exist or not (S24). In this example, the analyzing unit 3 is notified by the analyzed information managing unit 5 that only Style Information 1 exists. The process for Style Information 1 moves from “YES at S25” to S29. On the other hand, Style Information 3 does not exist in the analyzed information managing unit 5, so that the process for Style Information 3 moves from “NO at S25” to S26.
(3) The analyzing unit 3 reads Style Information 3 from the predetermined storage device 40 using the reading unit 2 based on the identifying information of “Style3.css” written in the screen information B (S26).
(4) The analyzing unit 3 analyzes Style Information 3 read from the storage device 40 (S27), and registers the analyzed result information which is an analyzed result of Style Information 3 with the common analyzed result information storing unit 50 of the analyzed information managing unit 5 as “the common analyzed result information 51” (S28). On this registration, together with the identifying information of “Style3.css”, the analyzed result of Style Information 3 is registered with the common analyzed result information storing unit 50 of the analyzed information managing unit 5 as the common analyzed result information. The process at S29 is the same as the one of the screen information A.
(5) The subsequent process of the displaying format determining unit 7 is the same as the one of the screen information A.

As discussed, the information displaying device 1 according to the second embodiment reuses the information which has been once analyzed (the style information, for example), which reduces the time required for analyzing pages which uses the same common resource.

### Embodiment 3

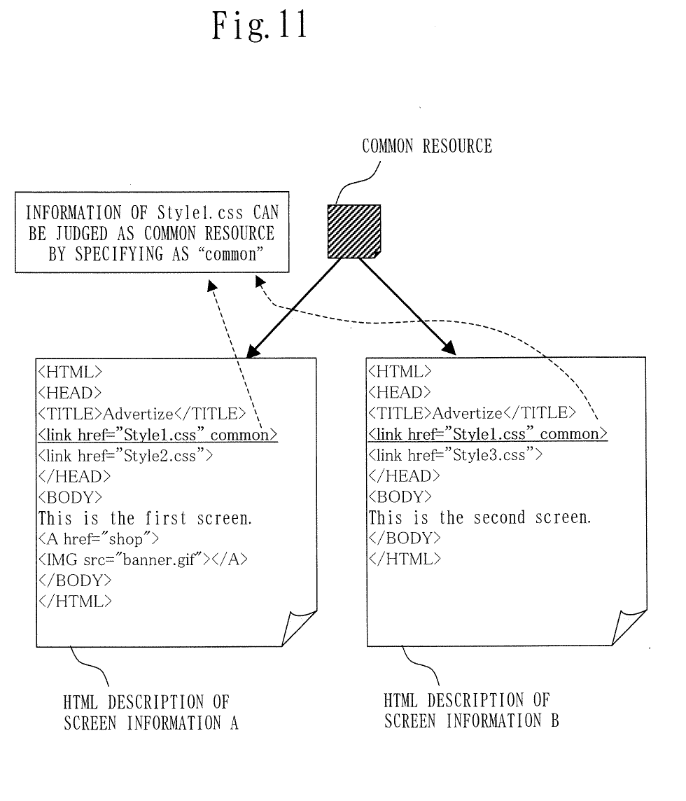

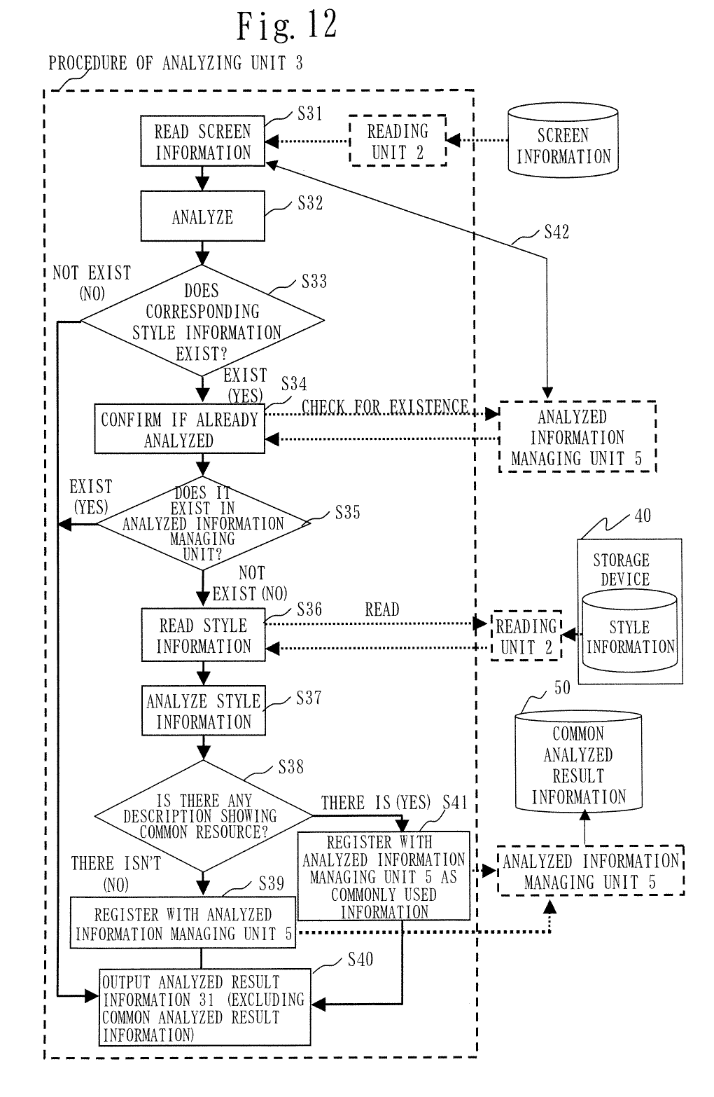

The information displaying device 1 according to the third embodiment will be explained by referring to FIGS. 11 and 12. The process of the third embodiment is similar to the case of the second embodiment. The third embodiment is an embodiment which efficiently manages the analyzed result information based on an identifier (“common” which will be discussed later) previously appended to the screen information showing that it is common resource. The configuration of the information displaying device 1 is the same as FIG. 8 showing the second embodiment.

An example of description of the screen information is shown in FIG. 11. Although FIG. 11 is almost the same as the example of description shown in FIG. 9 of the second embodiment, in the screen information, an identifier of “common” showing that it is commonly used by a plurality of screens is appended to the identifying information (the specifying information) showing the required style information (an example of displaying information).

As shown in FIG. 11, the identifier of “common” showing the common resource has been written previously for the common resource which will be used in the subsequent screens.

### (Process of the Screen Information A)

FIG. 12 shows a processing flow of the analyzing unit 3. In FIG. 12, processes from S31 to S37 are the same as the ones from S21 to S27 in FIG. 10 in the second embodiment. Different point from FIG. 10 is processes from S38. The processes from S38 will be explained.

At S38, on registering the analyzed result of the style information with the analyzed information managing unit 5, if the identifying information showing this style information includes the identifier of “common”, the analyzing unit 3 registers the analyzed style information shown by the identifying information having “common” with the common analyzed result information storing unit 50 of the analyzed information managing unit 5 as information to be commonly used with other screen information (“identifier related information”, hereinafter) (S41). On the other hand, if the identifying information showing this style information does not include the identifier of “common” (NO at S38), the analyzing unit 3 registers the analyzed style information with the common analyzed result information storing unit 50 as the common analyzed result information similarly to the case of second embodiment (S39). In this example, the analyzed Style Information 1 (an example of analyzed displaying information) is registered with the common analyzed result information storing unit 50 as the identifier related information, and the analyzed Style Information 2 (an example of analyzed displaying information) is not registered as the identifier related information but registered as the common analyzed result information. S40 is the same as S29 of FIG. 10.

The subsequent outputting process is the same as the one of FIG. 7 of the second embodiment. Namely, the displaying format determining unit 7 reads the analyzed result information 31 of the screen information A from the analyzing unit 3 (S11). Next, the displaying format determining unit 7 asks the analyzed information managing unit 5 to obtain the style information (an example of analyzed displaying information) related to specification of the identifying information (specifying information) included in the analyzed result information 31 (S12). Necessary common analyzed result information 51 is stored in the common analyzed result information storing unit 50 based on the reading process at S36 of FIG. 12. Therefore, the displaying format determining unit 7 can obtain the style information (Style Information 1, Style Information 2) related to specification of the identifying information from the analyzed information managing unit 5. The displaying format determining unit 7 reflects the style information obtained from the analyzed information managing unit 5 to the analyzed result information 31 of the screen information A and determines the outputting format (displaying format) of the screen A (S13). Then, the displaying format determining unit 7 outputs the information of the determined displaying format of the screen A to the information outputting unit 8 (S14). The information outputting unit 8 uses the information of the displaying format outputted by the displaying format determining unit 7 and carries out screen output of the screen A.

### (Process of the Screen Information B)

Next, as for the process to transit to the screen B described by the screen information B, the difference from the second embodiment will be discussed.

### (Deletion of the Common Analyzed Result Information)

At the time of transiting the screen, the analyzed information managing unit 5 deletes the common analyzed result information other than the one registered as the identifier related information (S42). In this example, the Style Information 1 shown by “Style1.css” is the identifier related information. Because of this, the analyzed information managing unit 5 does not delete the analyzed Style Information 1 from the common analyzed result information storing unit 50. On the other hand, “Style Information 2” shown by “Style2.css” is not the identifier related information. Therefore, the analyzed information managing unit 5 deletes the analyzed Style Information 2 registered with the common analyzed result information storing unit 50 as the common analyzed result information (S42).

The subsequent process moves to S31, S32, YES at S33, and S34.

(1) At S34, the analyzing unit 3 inquires the analyzed information managing unit 5 about the existence of the Style Information 1 and the Style Information 3. In this example, the analyzing unit 3 is notified by the analyzed information managing unit 5 that only the Style Information 1 exists (the Style Information 2 has been deleted at S42). The process for the Style Information 1 moves from “YES at S35” to S40. On the other hand, since the Style Information 3 does not exist in the analyzed information managing unit 5, the process for the Style Information 3 moves from “NO at S35” to S36.
(2) The analyzing unit 3 reads the Style Information 3 from the predetermined storage device 40 using the reading unit 2 based on the identifying information of “Style3.css” written in the screen information B.
(3) The analyzing unit 3 analyzes the Style Information 3 read from the storage device 40 (S37). The identifying information “Style3.css” does not include the description of “common” (NO at S38). Therefore, the analyzing unit 3 registers the analyzed result information of the Style Information 3 not as the identifier related information but as “normal” common analyzed result information 51 with the common analyzed result information storing unit 50 of the analyzed information managing unit 5 (S39). At S40, the analyzing unit 3 outputs the analyzed result information 31 to the displaying format determining unit 7.
(4) The subsequent operation of the displaying format determining unit 7 and the information outputting unit 8 is the same as the one for the screen information A.

In this manner, by adding the description (the identifier) showing the common resource to the screen information, it is possible to carry out the analyzing process using the common resource based on the description. By maintaining necessary common resource and by deleting the other, necessary memory capacity can be reduced compared with the second embodiment in which all the common analyzed result information are maintained.

If the specified common resource is not used in the next screen information, by once deleting the specified common resource, the processing is done normally from the first.

### Embodiment 4

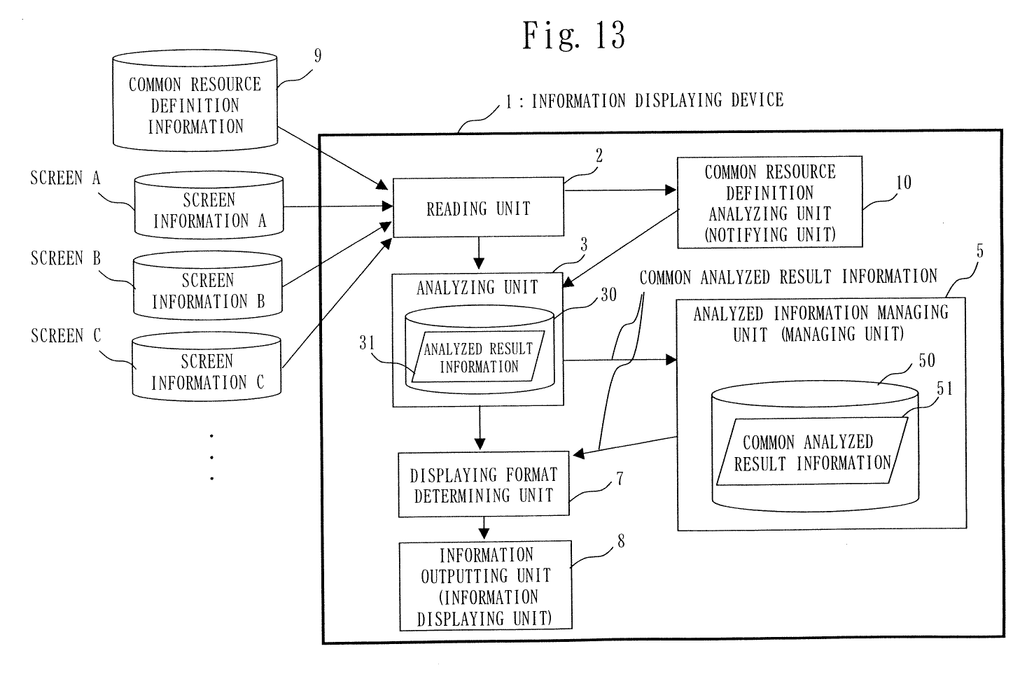

The fourth embodiment will be explained by using FIGS. 13 through 15. FIG. 13 is a block diagram showing a configuration of the information displaying device 1 according to the fourth embodiment. The information displaying device 1 of FIG. 13 further includes a common resource definition analyzing unit 10 (an example of a notifying unit) in addition to the information displaying device 1 of FIG. 3 of the first embodiment. While the reading unit 2 of the first embodiment reads the common resource 60, the reading unit 2 of FIG. 13 reads common resource definition information 9 (an example of corresponding information) which is information defining common resource and screen information using the common resource. The common resource definition analyzing unit 10 analyzes and maintains the common resource definition information 9 read by the reading unit 2.

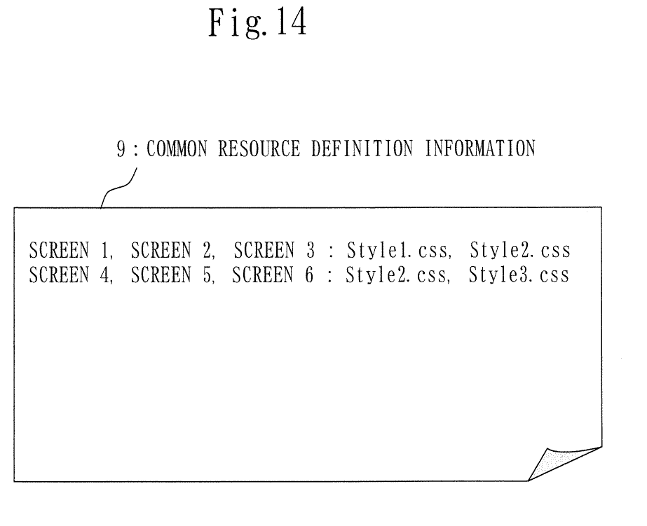

The information displaying device 1 according to the first embodiment reads and maintains the common resource beforehand. On the contrary to this, in the fourth embodiment, the common resource definition information 9 which previously defines to which screen the common resource is applied is prepared, and the common resource is switched and processed according to the definition. FIG. 14 shows an example of description of the common resource definition information 9. The identifying information of the screen is specified in the left side of a separator of “:”, and the identifying information of the common resource used in a specified screen is written in the right side. For example, in the example of FIG. 14, the style information “Style1.css” and “Style2.css” are defined commonly in the screens 1, 2, and 3, and the style information “Style2.css” and “Style3.css” are defined commonly in the screens 4, 5, and 6.

The information displaying device 1 according to the fourth embodiment first reads the common resource definition information 9 using the reading unit 2. The common resource definition information 9 is analyzed by the common resource definition analyzing unit 10. The common resource definition analyzing unit 10 maintains the information related to the common resource used for each screen (the analyzed common resource definition information 9).

### (Explanation of Operation)

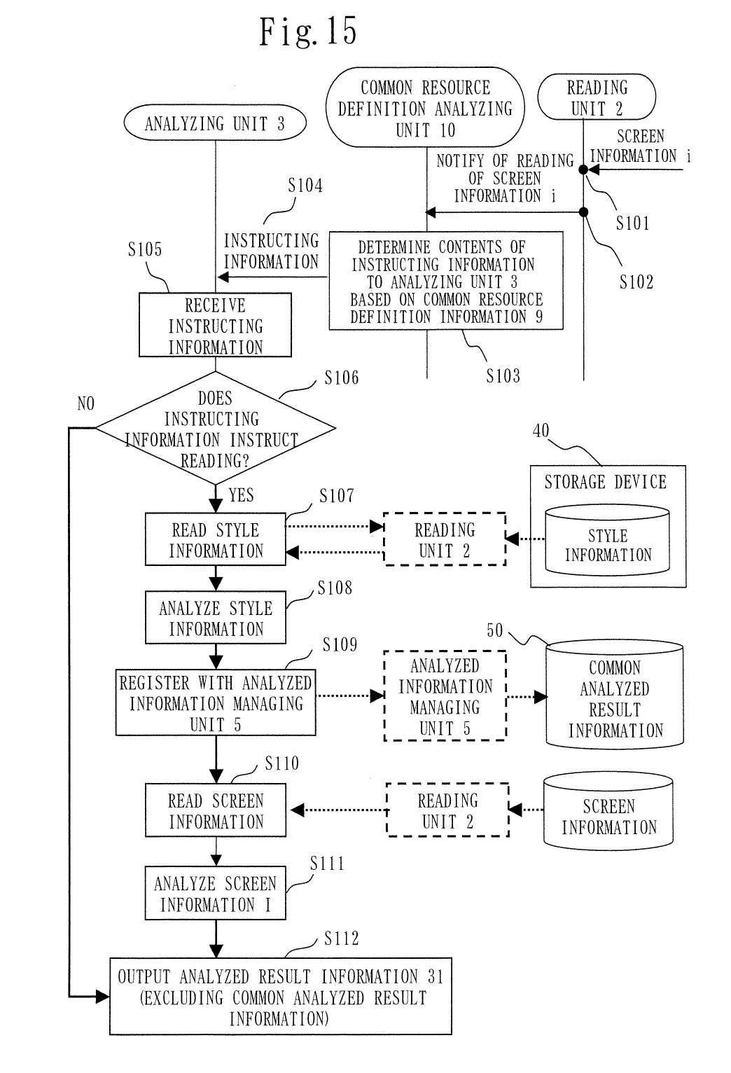

In the following, the operation of the information displaying device 1 according to the fourth embodiment will be explained by referring to FIG. 15. FIG. 15 is a flowchart showing the operation of the information displaying device 1 according to the fourth embodiment.

### (Case of Screen Information 1)

The screen information corresponding to the screen 1 through the screen 6 of FIG. 14 are called as the screen information 1 through the screen information 6. First, the reading unit 2 reads the screen information 1 (S101). When the screen information 1 is read, the reading unit 2 notifies the common resource definition analyzing unit 10 that the screen information 1 is read (S102). The reading unit 2 notifies the common resource definition analyzing unit 10 that the screen information is read at each time when the screen information is read.

Notified by the reading unit 2, the common resource definition analyzing unit 10 checks the common resource used for the screen 1 based on the maintained analyzed common resource definition information 9. The common resource definition analyzing unit 10 receives notification from the reading unit 2 every time when the reading unit 2 reads the screen information, and by referring to the common resource definition information 9 maintained by the common resource definition analyzing unit 10, the common resource definition analyzing unit 10 confirms if the style information (the displaying information) corresponding to the screen information read by the reading unit 2 exists or not. Then, as a result of confirmation, if there exists the style information, the common resource definition analyzing unit 10 judges if the style information related to the confirmation has been already notified to the analyzing unit 3 or not. As a result of the confirmation, if it has not been notified, “instructing information” instructing to read the style information related to the confirmation is sent to the analyzing unit 3. If it has already been notified, “the instructing information” instructing that reading the style information is unnecessary is sent to the analyzing unit 3 (S103, S104).

For example, in the screen 1 in the example of FIG. 14, the style information shown by “Style1.css” and the style information shown by “Style2.css” are defined as the common resource. Consequently, the common resource definition analyzing unit 10 generates the instructing information instructing to read Style Information 1 (displaying information) and Style Information 2 (displaying information) which are common resource and sends to the analyzing unit 3 (S104).

Receiving the instructing information from the common resource definition analyzing unit 10 (S105), the analyzing unit 3 checks if the received instructing information instructs to read the style information or not (S106). If the instructing information instructs to read specific common resource (Style Information 1 and Style Information 2, in this example), the analyzing unit 3 reads the common resource (Style Information 1 and Style Information 2) related to the instruction from the predetermined storage device 40 using the reading unit 2 (S107) and analyzes the read common resource (S108). The analyzing unit 3 registers the analyzed result of the Style Information 1 and the Style Information 2 which are the common resource with the common analyzed result information storing unit 50 of the analyzed information managing unit 5 as the common analyzed result information (an example of analyzed displaying information) (S109). When there exist a plurality of specifications such as “Style1.css” and “Style2.css”, the analyzing unit 3 sequentially reads the style information from the storage device 40 and analyzes them. Further, the analyzing unit 3 receives the screen information 1 from the reading unit 2 (S110) and analyzes the received screen information 1 (S111). The analyzing unit 3 outputs the analyzed result information 31 to the displaying format determining unit 7 at S112. The analyzed result information 31 has the same contents as the one of the second embodiment. Namely, the information outputted by the analyzing unit 3 at S112 to the displaying format determining unit 7 does not include the style information analyzed at S108 (the common analyzed result information). The style information analyzed (common analyzed result information) at S108 is obtained by the displaying format determining unit 7 at S12 of FIG. 7 as will be discussed in the following.

### (Displaying Screen 1: Process by Displaying Format Determining Unit 7)

The analyzing unit 3 outputs the analyzed result information 31 of the screen information 1 to the displaying format determining unit 7, and the subsequent process is the same as the one of FIG. 7 explained in the first embodiment. Namely, the displaying format determining unit 7 reads the analyzed result information 31 of the screen information 1 from the analyzing unit 3 (S11). Next, the displaying format determining unit 7 asks the analyzed information managing unit 5 to obtain the style information specified by the identifying information included in the analyzed result information 31 (the Style Information 1 and the Style Information 2 in this example) (S12). The necessary style information has been registered by the processes of S107 through S109 of FIG. 15. Therefore, the displaying format determining unit 7 can obtain the Style Information 1 and the Style Information 2 specified by the identifying information from the analyzed information managing unit 5. The displaying format determining unit 7 reflects the style information obtained from the analyzed information managing unit 5 to the analyzed result information 31 of the screen information 1 and determines the outputting format (the displaying format) of the screen 1 (S13). Then, the displaying format determining unit 7 outputs the information of the determined displaying format of the screen 1 to the information outputting unit 8 (S14). The information outputting unit 8 uses the information of the displaying format outputted by the displaying format determining unit 7 and carries out screen output of the screen 1.

As for displaying the screen 2 and the screen 3, the reading unit 2 notifies the common resource definition analyzing unit 10 of reading each screen information. Here, the screen 2 and the screen 3 can, as understood by referencing the common resource definition information 9, use the common analyzed result information (the Style Information 1 and the Style Information 2) which are the same as the screen 1. Therefore, the common resource definition analyzing unit 10 does not instruct to read the style information. Namely, in the case of the screen 2 and the screen 3, at S103, the common resource definition analyzing unit 10 sends “the instructing information” to instruct that there is no need to read the style information to the analyzing unit 3 (S104). Receiving “the instructing information” (S105), the analyzing unit 3 does not read the style information from the storage device (NO at S106), but processes the screen information (S112). The subsequent process is the same as the one for the screen 1.

### (Reading Screen 4)

When newly transiting to the screen 4 (S101), as well as the case for the screen 1, the reading unit 2 notifies the common resource definition analyzing unit 10 of reading the screen information of the screen 4 (S102). In the case of the screen 4, the common resource definition analyzing unit 10 refers to the common resource definition information 9 and judges the style information necessary for the screen 4 (S103). The screen 4 does not need the Style Information 1 and the Style Information 2 which have been used, but needs the Style Information 2 and the Style Information 3. Therefore, the common resources are switched. Since the Style Information 2 has been already notified, the Style Information 2 is stored in the common analyzed result information storing unit 50. The information displaying device 1 uses this information. Namely, the displaying format determining unit 7 asks the analyzed information managing unit 5 to obtain the Style Information 2 as well as the Style Information 3 (S12 in FIG. 7). The common resource definition analyzing unit 10 notifies the analyzing unit 3 of “the instructing information” to instruct to read only the Style Information 3 (S1104). The analyzing unit 3 reads the Style Information 3 shown by “Style3.css” from the storage device 40 through the reading unit 2 as the common resource (S107), and analyzes it (S108). The analyzing unit 3 registers the analyzed result of the Style Information 3 with the common analyzed result information storing unit 50 of the analyzed information managing unit 5 as the common analyzed result information (S109). The analyzing unit 3 receives the analyzed result information 4 from the reading unit 2 (S110), and analyzes the received screen information 4 (S11). The subsequent process is the same as the one for the screen 1.

As discussed above, according to the information displaying device of the invention, since the screen information which can be processed as the common resource has been processed beforehand, it is possible to omit the analyzing process for displaying the screen, which enables to reduce the processing time for displaying.

As discussed above, according to the information displaying device of the invention, by reusing the screen information which has been used for the previous screen information as the common resource to be processed, the reading process beforehand becomes unnecessary, the definition of the screen information is facilitated, and also the analyzing process of the common resource can be omitted for displaying the screen, which enables to reduce the processing time for displaying.

As discussed above, according to the information displaying device of the invention, by describing the information related to the screen information which can be processed as the common resource in the screen information itself and by interpreting at the time of analyzing, it is possible to omit analyzing the common resource for processing the next screen, which enables to reduce the processing time for displaying.

As discussed above, according to the information displaying device of the invention, by preparing the information related to the screen information which can be processed as the common resource and the information of the screen to be applied, and by analyzing them beforehand, the common resource can be judged for each screen. Therefore, it is possible to process only necessary part of the common resource, which prevents consuming unnecessary memory.

The information displaying device explained in the first embodiment processes/maintains the common resource information used for a plurality of screens by separating from the other analyzed information, and uses the information which has been once analyzed without any further analysis, so that it is possible to reduce the processing time to output the screen information.

Further, the information displaying device explained in the second embodiment checks if it is possible to reuse the information which has been previously displayed by comparing URI of each related information used in a plurality of pages, and if there is a match, the analyzing information can be reduced by using the matched URI.

Further, the information displaying device explained in the third embodiment, when the screen information includes the specifying description of the common resource which is used for a plurality of screens, judges the common resource by using the specifying description and uses the common resource, which enables to reduce the analyzing information.

Further, the information displaying device explained in the fourth embodiment describes an applicable range of objects of the common resource and uses the common resource determined only for the applied object, which enables to switch the common resource smoothly.

In the above first embodiment, in the information displaying device which uses the contents analyzing/displaying function of the browser to display the information, the information displaying device including a reading unit reading screen information, an analyzing unit analyzing the read screen information and outputting the analyzed result information, an analyzed information managing unit managing the analyzed result information with separating into the common part and the other, a displaying format determining unit determining an outputting format based on the analyzed result information, and an information outputting unit carrying out an output based on the information determined by the displaying format determining unit has been explained.

In the above second embodiment, the information displaying device including the analyzing unit generating analyzed result information by using the information used for the previous screen and an analyzed information managing unit has been explained.

In the above third embodiment, the information displaying device including an analyzing unit analyzing the screen information in which the information of the common part has been previously described and an analyzed information managing unit has been explained.

In the above fourth embodiment, the information displaying device including a common resource definition information analyzing unit analyzing definition information related to common resource and switching common resources has been explained.

Having thus described several particular embodiments of the present invention, various alterations, modifications, and improvements will readily occur to those skilled in the art. Such alterations, modifications, and improvements are intended to be part of this disclosure, and are intended to be within the spirit and scope of the present invention. Accordingly, the foregoing description is by way of example only, and is not intended to be limiting. The present invention is limited only as defined in the following claims and the equivalents thereto.

1. An information displaying device for reading and analyzing each of screen information which is defined as information showing a predetermined screen and includes specifying information specifying displaying information necessary to display the predetermined screen, and displaying the predetermined screen for each of the screen information analyzed, the information displaying device comprising:
a managing unit storing analyzed displaying information which is the displaying information after analyzing and managing the analyzed displaying information stored;
a reading unit sequentially reading each of the screen information;
an analyzing unit inputting the screen information read by the reading unit, generating analyzed result including the specifying information included in the screen information by analyzing the screen information inputted, and outputting the analyzed result generated;
a displaying format determining unit inputting the analyzed result outputted by the analyzing unit, asking the managing unit to obtain the analyzed displaying information of the displaying information specified by the specifying information included in the analyzed result inputted, and when the analyzed displaying information is obtained from the managing unit, determining a displaying format of the predetermined screen shown by the screen information which is an origin of the analyzed result inputted from the analyzing unit based on the analyzed displaying information obtained from the managing unit and the analyzed result inputted from the analyzing unit; and
an information displaying unit displaying the predetermined screen according to the displaying format determined by the displaying format determining unit.

2. The information displaying device of claim 1,
wherein the reading unit reads predetermined displaying information,
wherein the analyzing unit generates the analyzed displaying information of the predetermined displaying information by analyzing the predetermined displaying information read by the reading unit, and
wherein the managing unit stores the analyzed displaying information of the predetermined displaying information generated by the analyzing unit.

3. The information displaying device of claim 1,
wherein at least two of the screen information read by the reading unit include specifying information specifying same displaying information.

4. The information displaying device of claim 2,
wherein at least two of the screen information read by the reading unit include specifying information specifying same displaying information.

5. The information displaying device of claim 1,
wherein the analyzing unit inquires the managing unit if the analyzed displaying information of the displaying information specified by the specifying information included in the analyzed result generated exists or not, if the analyzed displaying information of the displaying information does not exist in the managing unit as a result of inquiry, reads the displaying information specified by the specifying information from a predetermined storage device using the reading unit, analyzes the displaying information read, outputs the analyzed result of the screen information to the displaying format determining unit as well as registers analyzed result of the displaying information with the managing unit as new analyzed displaying information, and if the analyzed displaying information of the displaying information exists in the managing unit as a result of inquiry, does not read the displaying information but outputs the analyzed result of the screen information to the displaying format determining unit.

6. The information displaying device of claim 2,
wherein the analyzing unit inquires the managing unit if the analyzed displaying information of the displaying information specified by the specifying information included in the analyzed result generated exists or not, if the analyzed displaying information of the displaying information does not exist in the managing unit as a result of inquiry, reads the displaying information specified by the specifying information from a predetermined storage device using the reading unit, analyzes the displaying information read, outputs the analyzed result of the screen information to the displaying format determining unit as well as registers analyzed result of the displaying information with the managing unit as new analyzed displaying information, and if the analyzed displaying information of the displaying information exists in the managing unit as a result of inquiry, does not read the displaying information but outputs the analyzed result of the screen information to the displaying format determining unit.

7. The information displaying device of claim 3,
wherein the analyzing unit inquires the managing unit if the analyzed displaying information of the displaying information specified by the specifying information included in the analyzed result generated exists or not, if the analyzed displaying information of the displaying information does not exist in the managing unit as a result of inquiry, reads the displaying information specified by the specifying information from a predetermined storage device using the reading unit, analyzes the displaying information read, outputs the analyzed result of the screen information to the displaying format determining unit as well as registers analyzed result of the displaying information with the managing unit as new analyzed displaying information, and if the analyzed displaying information of the displaying information exists in the managing unit as a result of inquiry, does not read the displaying information but outputs the analyzed result of the screen information to the displaying format determining unit.

8. The information displaying device of claim 4,
wherein the analyzing unit inquires the managing unit if the analyzed displaying information of the displaying information specified by the specifying information included in the analyzed result generated exists or not, if the analyzed displaying information of the displaying information does not exist in the managing unit as a result of inquiry, reads the displaying information specified by the specifying information from a predetermined storage device using the reading unit, analyzes the displaying information read, outputs the analyzed result of the screen information to the displaying format determining unit as well as registers analyzed result of the displaying information with the managing unit as new analyzed displaying information, and if the analyzed displaying information of the displaying information exists in the managing unit as a result of inquiry, does not read the displaying information but outputs the analyzed result of the screen information to the displaying format determining unit.

9. The information displaying device of claim 5,
wherein the specifying information includes a predetermined identifier,
wherein the analyzing unit, when the displaying information is read from the predetermined storage device using the reading unit, registers the analyzed displaying information of the displaying information read from the predetermined storage device with the managing unit as identifier related information, and
wherein the managing unit, when the reading unit reads next screen information, deletes information stored other than the identifier related information.

10. The information displaying device of claim 6,
wherein the specifying information includes a predetermined identifier,
wherein the analyzing unit, when the displaying information is read from the predetermined storage device using the reading unit, registers the analyzed displaying information of the displaying information read from the predetermined storage device with the managing unit as identifier related information, and
wherein the managing unit, when the reading unit reads next screen information, deletes information stored other than the identifier related information.

11. The information displaying device of claim 7,
wherein the specifying information includes a predetermined identifier,
wherein the analyzing unit, when the displaying information is read from the predetermined storage device using the reading unit, registers the analyzed displaying information of the displaying information read from the predetermined storage device with the managing unit as identifier related information, and
wherein the managing unit, when the reading unit reads next screen information, deletes information stored other than the identifier related information.

12. The information displaying device of claim 8,
wherein the specifying information includes a predetermined identifier,
wherein the analyzing unit, when the displaying information is read from the predetermined storage device using the reading unit, registers the analyzed displaying information of the displaying information read from the predetermined storage device with the managing unit as identifier related information, and
wherein the managing unit, when the reading unit reads next screen information, deletes information stored other than the identifier related information.

13. The information displaying device of claim 1, further comprising:
a noting unit, as well as keeping correspondence information showing correspondence between the displaying information and the screen information, each time when the reading unit reads the screen information, confirming if the displaying information corresponding to the screen information read by the reading unit exists or not by referring to the correspondence information, as a result of confirmation, if the displaying information exists, checking if the displaying information related to the confirmation has been already notified to the analyzing unit or not, and if not notified yet, notifying the analyzing unit of the displaying information related to the confirmation,
wherein the analyzing unit, when notified by the notifying unit, reads the displaying information related to notification from a predetermined storage device using the reading unit, analyzes the displaying information read and registers analyzed result with the managing unit as new analyzed displaying information.

14. The information displaying device of claim 2, further comprising:
a notifying unit, as well as keeping correspondence information showing correspondence between the displaying information and the screen information, each time when the reading unit reads the screen information, confirming if the displaying information corresponding to the screen information read by the reading unit exists or not by referring to the correspondence information, as a result of confirmation, if the displaying information exists, checking if the displaying information related to the confirmation has been already notified to the analyzing unit or not, and if not notified yet, notifying the analyzing unit of the displaying information related to the confirmation,
wherein the analyzing unit, when notified by the notifying unit, reads the displaying information related to notification from a predetermined storage device using the reading unit, analyzes the displaying information read and registers analyzed result with the managing unit as new analyzed displaying information.

15. The information displaying device of claim 3, further comprising:
a notifying unit, as well as keeping correspondence information showing correspondence between the displaying information and the screen information, each time when the reading unit reads the screen information, confirming if the displaying information corresponding to the screen information read by the reading unit exists or not by referring to the correspondence information, as a result of confirmation, if the displaying information exists, checking if the displaying information related to the confirmation has been already notified to the analyzing unit or not, and if not notified yet, notifying the analyzing unit of the displaying information related to the confirmation,
wherein the analyzing unit, when notified by the notifying unit, reads the displaying information related to notification from a predetermined storage device using the reading unit, analyzes the displaying information read and registers analyzed result with the managing unit as new analyzed displaying information.

16. The information displaying device of claim 4, further comprising:
a notifying unit, as well as keeping correspondence information showing correspondence between the displaying information and the screen information, each time when the reading unit reads the screen information, confirming if the displaying information corresponding to the screen information read by the reading unit exists or not by referring to the correspondence information, as a result of confirmation, if the displaying information exists, checking if the displaying information related to the confirmation has been already notified to the analyzing unit or not, and if not notified yet, notifying the analyzing unit of the displaying information related to the confirmation,
wherein the analyzing unit, when notified by the notifying unit, reads the displaying information related to notification from a predetermined storage device using the reading unit, analyzes the displaying information read and registers analyzed result with the managing unit as new analyzed displaying information.

17. An information displaying method performed by an information displaying device reading and analyzing each of screen information which is defined as information showing a predetermined screen and includes specifying information specifying displaying information necessary to display the predetermined screen, and displaying the predetermined screen for each of the screen information analyzed, the information displaying method comprising:
by a managing unit, storing analyzed displaying information which is the displaying information after analyzing and managing the analyzed displaying information stored;
by a reading unit, sequentially reading each of the screen information;
by an analyzing unit, inputting the screen information read by the reading unit, generating analyzed result including the specifying information included in the screen information by analyzing the screen information inputted, and outputting the analyzed result generated;
by a displaying format determining unit, inputting the analyzed result outputted by the analyzing unit, asking the managing unit to obtain the analyzed displaying information of the displaying information specified by the specifying information included in the analyzed result inputted, and when the analyzed displaying information is obtained from the managing unit, determining a displaying format of the predetermined screen shown by the screen information which is an origin of the analyzed result inputted from the analyzing unit based on the analyzed displaying information obtained from the managing unit and the analyzed result inputted from the analyzing unit; and
by an information displaying unit, displaying the predetermined screen according to the displaying format determined by the displaying format determining unit.
